(19) United States
(12) Patent Application Publication
(10) Pub. No.: US 2002/0162985 A1
(43) Pub. Date: Nov. 7, 2002

(54) Flap valve with thin-walled pipe sealing

(76) Inventors: Ralph Krause, Stuttgart (DE); Uwe Knauss, Schwaebisch Gmuend (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/088,673

(22) PCT Filed: Jul. 20, 2001
(86) PCT No.: PCT/DE01/02659

(30) Foreign Application Priority Data
Jul. 21, 2000 (DE) 100 35 607.9

(51) Int. Cl. F16K 1/22

(52) U.S. Cl. 251/306; 251/359

(57) ABSTRACT

The invention relates to a flap valve for controlling a gas flow (9, 10), with a shielded tube (3), which conveys the gas flow, and a valve flap (6) disposed in it, which can pivot between an open position (18) and a closed position (17). The valve flap (6) is supported in a non-rotating fashion on an adjustable flap shaft (7) and in its closed position (17), covers the cross section (19) of the shielded tube (3) and in its open position (18), maximally opens this cross section. An acute angle α is enclosed between the axis (8) of the valve flap (6) and the axis (13) of the shielded tube (3). The pivotable valve flap (6) is encompassed in the shielded tube (3) by a valve tube (4), which contains a decoupling element (21).

### TECHNICAL FIELD

A flap valve can be used to control the mass flow of a medium such as air or exhaust in a conduit. In order to achieve a low amount of leakage when the flap valve is closed, on the one hand, the diameter of the flap must be slightly greater than or equal to the inner diameter of the conduit in which the flap is movably contained. On the other hand, the valve tube in the flap region must be elastically deformable in order to assure a sufficient deformation during the closing of the flap to achieve an optimal sealing action.

### PRIOR ART

DE 197 13 578 A1 relates to an admixing valve, in particular a return valve for exhaust in an internal combustion engine. The admixing valve is designed with a plastic housing, which is for conveying the cold fluid flow, and a connecting piece, which conveys a hot fluid flow, constitutes a sealing seat for a valve closing member, and is connected to the plastic housing. The connecting piece has an outlet opening via which the hot fluid flow is mixed with the cold fluid flow and has at least two flow surfaces. The flow surfaces extend lateral to the flow direction of the cold fluid flow and are disposed opposite each other. The flow surfaces are embodied as fluid-guiding plates, which are disposed at least in the vicinity of the outlet opening and shield the plastic housing from the hot fluid flow supplied.

DE 43 05 123 A1 relates to a throttle valve. Throttle valve devices can have intolerable leakage flows and a sluggishness in their actuation. The throttle valve device known from DE 43 05 123 A1, however, has bearing sleeves, which are radially mobile inside a housing recess, and when the throttle valve closes for the first time after installation these bearing sleeves compensate for measurement deviations between the stop faces and the throttle valve shaft bearing or the bores through bearing adaptation or a radial movement of the bearing sleeves. In comparison to the known devices, this device has a greater sealing action while simultaneously preventing actuation sluggishness and is particularly well-suited for use in internal combustion engines.

In addition, a flap valve is known for controlling a gas flow. The flap valve is contained in a valve tube that conveys a gas flow and a valve flap disposed in it, which can be pivoted between a closed position and an open position. The valve flap is non-rotatably supported on an adjustable flap shaft. In order avoid shaft fractures in the valve tube within the sealing region between the valve flap and the valve tube, the flap shaft is aligned so that its axis encloses an acute angle α with the axis of the valve tube. The valve flap non-rotatably fixed to the flap shaft is aligned so that in its closed position, it is normally aligned with the axis of the valve tube or extends at an acute angle to it.

The flap valve disclosed here is a rigid valve flap without an elastic, flexible sealing element. In order to achieve a low leakage in this apparatus, on the one hand, the diameter of the flap d must be greater than or equal to the valve tube diameter D. On the other hand, the valve tube must be elastically flexible in the vicinity of the flap so that it can fulfill its sealing function when the flap closes.

### DEPICTION OF THE INVENTION

In order to provide the component of the valve tube with a multiple functionality, a thin-walled decoupling element in the form of a bellows-shaped compensation region is accommodated in the tube. The thin-walled decoupling element is disposed between the fixed mount and the free end of the valve tube. The radial stress on the free end of the tube is produced by a pivoting motion of the throttle valve, which can be brought from a closed position into an open position and vice versa in the valve tube by the adjusting motor connected to it. As a result, a radially acting deformation is imparted to the valve tube, which is possible by means of the thin-walled decoupling element due to its inherent flexibility. The deformation of the valve tube assures a maximal sealing action when the valve flap is closed.

The decoupling element can be embodied in the form of one or more axial waves connected in series. Due to the thin-walled embodiment of the decoupling element, the moment that the adjusting motor must exert in order to open or close the valve flap associated with it is minimal. The moment to be exerted depends heavily on the radial flexibility of the decoupling element. The greater the flexibility, i.e. the deformability, of the decoupling element, the less driving torque that has to be exerted to pivot the valve flap, i.e. the smaller the adjusting motor and its restoring spring can be.

In addition to the radial flexibility, the decoupling element also provides a distinct angular or lateral flexibility, as a result of which measurement deviations due to manufacturing tolerances and heat expansion differences can be compensated for. This permits the rotatable valve flap to be designed with greater tolerances, which significantly reduces manufacturing and finishing costs.

The multiaxial flexibility of the valve tube in the vicinity of the valve flap is greater the closer the decoupling element is to the stationary mounted tube end and the greater the free tube length between the decoupling element and the valve flap region in the tube. The embodiment proposed according to the invention achieves a sealing possibility for a mobile valve flap in a valve tube, which requires a minimal driving torque for adjusting while permitting a maximal sealing action to be achieved.

### DRAWINGS

The invention will be described in detail below in conjunction with the drawings.

FIG. 1 shows the cross section through a flap valve configuration provided according to the invention, with a valve flap, which can be pivoted by an adjusting motor and is encompassed by a valve tube with the decoupling element proposed according to the invention,

FIGS. 2.1 to 2.3 show embodiments of the decoupling element, with a wave formation that points inward and outward,

FIG. 3 shows a decoupling element with a horizontally disposed wave formation, and

FIGS. 4.1, 4.2 show decoupling elements with combined wave deformations in the compensation region.

### EMBODIMENTS

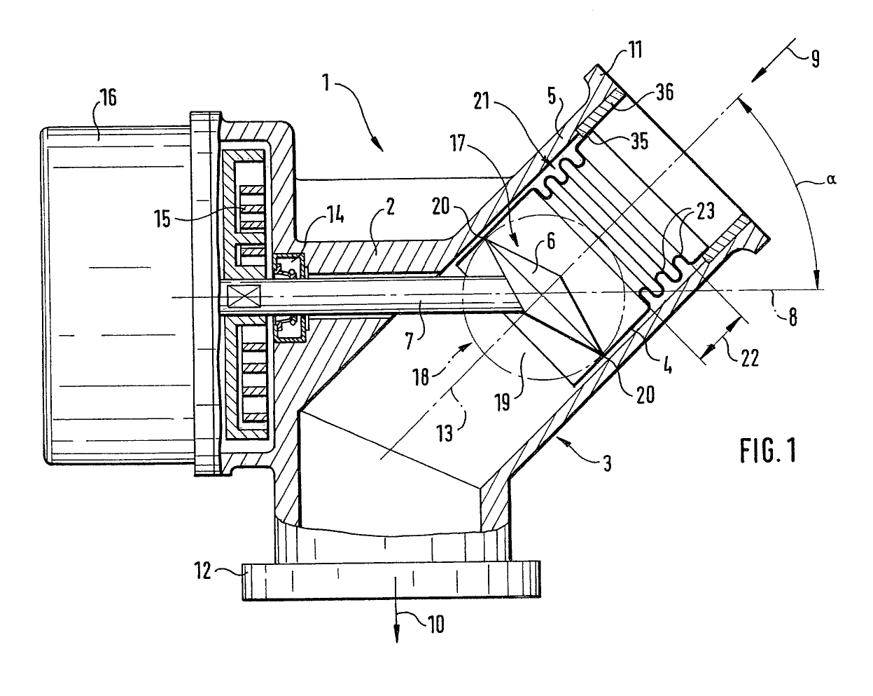

FIG. 1 shows the cross section through a flap valve configuration proposed according to the invention, where the actuation axis of the valve flap encloses an angle α in relation to the symmetry axis of the valve tube.

The flap valve 1 includes a valve housing 2, which is laterally flange-mounted to a shielded tube 3. Inside the shielded tube 3, there is a thin-walled valve tube 4, which is encompassed by the fitting 5 of the shielded tube 3, forming an annular gap. A flap shaft 7 passes through the valve housing 2 of the flap valve 1 and the axis 8 of this shaft is oriented at the angle α in relation to the fitting axis 13 of the shielded tube 3 so that an acute angle α is enclosed between the axes 8 and 13. A gas flow passes through the shielded tube 3 in the direction of the arrows 9 and 10 shown, where the flow in the fitting 5 of the shielded tube 3 depends on the angular position of the valve flap 6. Connecting flanges 11 and 12 are provided on the shielded tube 3 and permit the valve tube to be connected in a gas-tight fashion to other structural elements, for example in the suction system of an internal combustion engine.

According to the depiction in FIG. 1, the valve flap 6, which is disposed at right angles to the fitting axis 13 of the valve tube 3, can be adjusted by means of the flap shaft 7. An adjusting motor 16, which drives the flap shaft 7 to rotate, is used to adjust the flap shaft. The adjusting motor 16 is connected to a restoring spring 15, which can be embodied, for example, as a flat spiral spring. Underneath the flat spiral spring, the valve housing 2 is closed off from the bore that the flap shaft 7 passes through by means of a sealing ring 14.

In the depiction according to FIG. 1, the valve flap 6 that is non-rotatably affixed to the flap shaft 7, is shown with solid lines in its closed position. The closed position of the valve flap 6 is labeled with the reference numeral 17. In the closed position 17, the valve flap 6 is disposed in the position shown with solid lines in the cross section of the valve tube 4 and, with its outer edge regions in the contact region 20, rests in a sealed fashion against the inside of the valve tube 4. The incoming gas flow labeled with the reference numeral 9 is prevented from passing through the cross sectional area of the valve tube 4. The sealing action is achieved by virtue of the fact that the edge regions on the circumference of the valve flap 6, which blocks the cross section of the cross sectional area 19, rest in a sealed fashion against the inner surfaces of the valve tube 4 in the contact region 20.

In the depiction according to FIG. 1, the valve tube 4 is provided with a decoupling element 21, which is accommodated on a tube 36 that protrudes into the shielded tube 3 in a fastening region 35. The fastening region 35, in which the decoupling element 21 is connected to the tubular insert 36 of the shielded tube 3, is adjoined by a region of the decoupling element 21, which region, in the depiction according to FIG. 1, is embodied as a bellows-shaped compensation region 22. This gives the decoupling element 21 a multiaxial flexibility so that the decoupling element 21 compensates for the pivoting motion transmitted to the valve flap 6 by the flap shaft 7 so that the outer circumference surfaces of the pivotable valve flap 6 are assured of contacting the wall 31 of the valve tube 4. In the closed position 17 of the valve flap 6, there is a linear contact between the circumference surface of the valve flap 6; if this valve flap 6 is moved out of its closed position 17, then there is a two-point contact with the wall 31 of the valve tube 4. The flexibility of the decoupling element therefore increases the sealing action of a valve flap 6/decoupling element 21 device significantly since during the rotation of the valve flap 6 by the flap shaft 7 from the closed position 17 into an open position 18, radial compensation movements take place, which can be compensated for by the flexibility of the decoupling element 21. This also assures a two-point contact of the valve flap 6 with the inner wall 31 of the valve tube 4 in the contact region 20 when the valve flap 6 is pivoted from the closed position 17 into the open position 18.

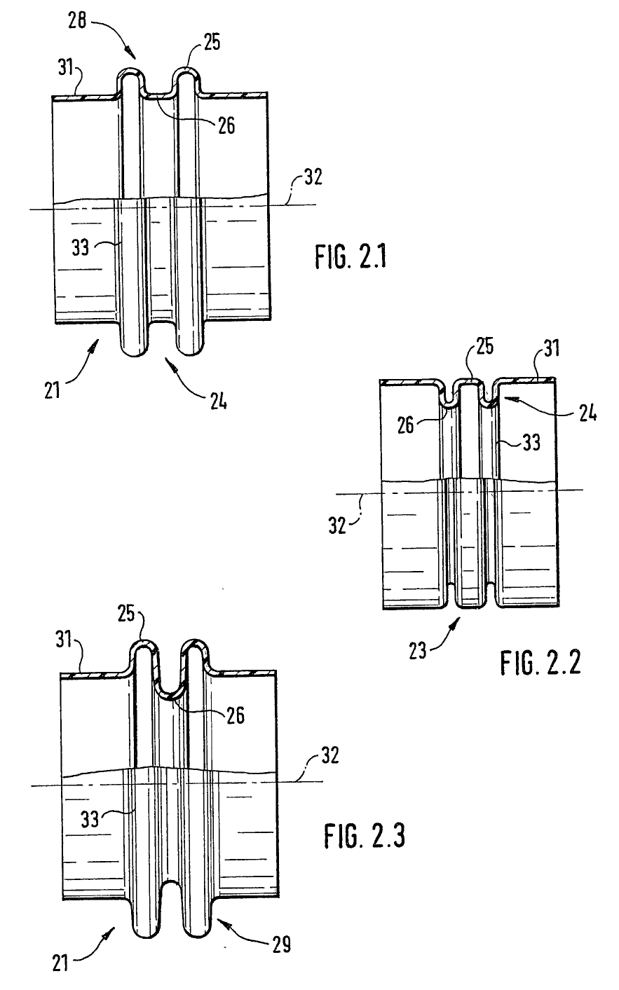

Other embodiments of the decoupling element, which is used according to the invention and is contained in the valve tube, are shown more clearly in the sequence of FIGS. 2.1 to 2.3.

FIG. 2.1 shows a thin-walled decoupling element 21, where the compensation region 22 is comprised of a wave formation that is composed of wave crests 25, which are characterized by vertical waves 24 produced in an outside position 28 and are disposed one after the other in the axial direction, and a wave trough 26 enclosed between them. In relation to the outer surface of the decoupling element 21, the wave trough 26 and the wave crests 25 respectively constitute circumferential edges 33. The decoupling element 21, which is produced as a shaped part made of plastic or metallic materials and is configured with a thin wall thickness 31, is embodied as symmetrical in relation to the symmetry line 32.

FIG. 2.2 shows an alternative embodiment of the decoupling element 21, which is once again embodied as a shaped part with a thin wall thickness 31 and is rotationally symmetrical in relation to its symmetry axis 32. In this embodiment of the decoupling element, the wave crest 25 is embodied in relation to the wave troughs 26 so that it is disposed on the outer surface of the decoupling element 21. As a result, in relation to the symmetry line 32 of the decoupling element 21, the wave troughs 26 produce throttle cross sections inside the decoupling element 21. The compensation region 23 is consequently provided with a desired deformation point, which gives the decoupling element 21 a multiaxial flexibility during rotation of the valve flap 6, which is encompassed by the decoupling element 21.

FIG. 2.3 shows a decoupling element 21, which is likewise designed to be rotationally symmetrical in relation to its symmetry axis 32. In this embodiment of the decoupling element 21, a vertical wave formation 29 is shown, which is comprised of wave crests 25 and a wave trough 26 between them. The combined wave formation is embodied in an outside position 28 and in an inside position 27 and is shaped similarly to the configuration of the decoupling element 21 shown in FIG. 2.1.

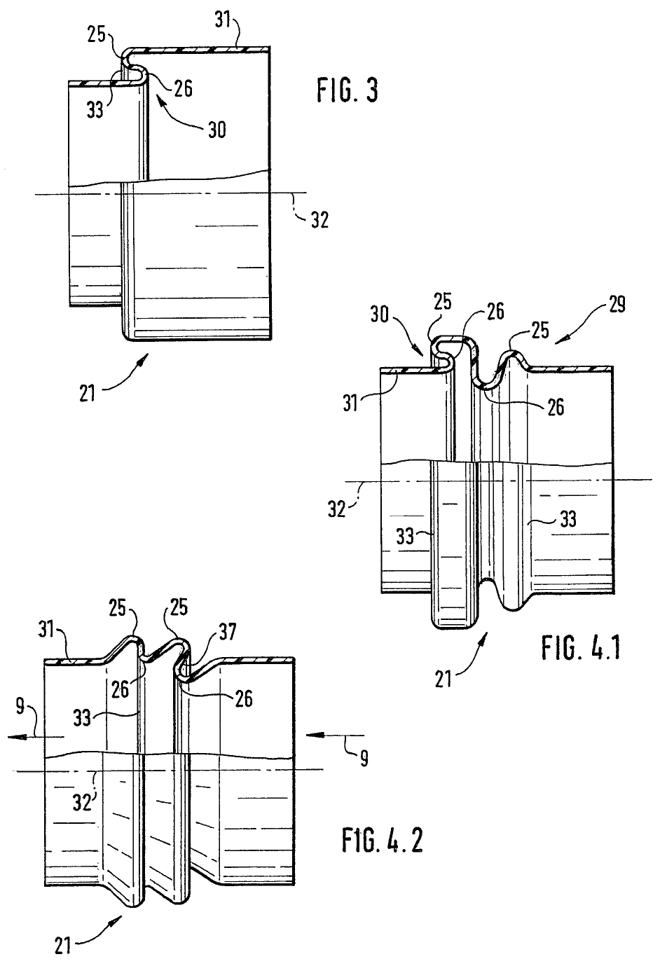

FIG. 3 shows another embodiment of the decoupling element to be inserted according to the invention into a valve tube. It can be assumed from the embodiment according to FIG. 3 that the decoupling element 21 is embodied with a horizontal wave 30 whose wave trough 26 and wave crest 25 are disposed one above the other in the radial direction of the decoupling element 21. The decoupling element 21 according to FIG. 3 is also embodied with a thin wall thickness 31 and made, for example, of plastic or a metallic material. It is rotationally symmetrical in relation to its symmetry axis 32 and gives the decoupling element 21 a multiaxial deformability.

The transition region or the fastening region 35 inside which the decoupling elements 21 are each connected to the fitting 5 of the shielded tube 3 encompassing them is not shown in detail in FIGS. 2.1 to 2.3 or in FIG. 3. Reference is made to the depiction according to FIG. 1 in which the fastening region 35 of the decoupling element 21 and the inner wall of the fitting 5 of the shielded tube 3 can be embodied as a glued connection. It is also possible to embody this connection as a frictional engagement or a form-fitting engagement; other possibilities are welded and soldered connections.

FIGS. 4.1 and 4.2 show other embodiments of the thin-walled decoupling element 21 proposed according to the invention.

It can therefore be inferred from the depiction in FIG. 4.1 that the decoupling element 21 can be provided with a compensation region 22 in relation to its symmetry line 32, which region contains a combined wave formation of vertical waves 29 and horizontal waves 30 (see FIG. 3). The compensation region embodied on the decoupling element 21 according to FIG. 4.1 contains a wave trough 26 in an inside position 27 and a wave crest 26 in an outside position 28 in relation to the circumference surface of the decoupling element 21. In addition, a wave formation in a horizontal formation 30 is embodied in the outlet region of the decoupling element 21, in which, analogous to the depiction in FIG. 3, a wave trough 26 and a wave crest 25 are disposed one above the other in the radial direction. The lower part of the depiction according to FIG. 4.1 shows the external configuration of a decoupling element 21 of this kind, which shows the circumferential edges 33 in the outer region of the decoupling element 21, which are produced by the shape according to the upper part of FIG. 4.1.

Finally, FIG. 4.2 shows another possible shape of a decoupling element proposed according to the invention.

The decoupling element 21, which according to FIG. 4.2 is likewise embodied with a thin wall thickness 31, has wave crests 25, depicted in an outside position 28, which enclose a wave trough 26 between them. Furthermore, between a wave crest 25 and a wave trough 26, a wave formation on the decoupling element 21 can be provided with an inclined flank 37, which can be embodied as transitioning into a wave trough 26. The wave trough 26 on the decoupling element 21 in turn transitions into a circumference region of the decoupling element 21, which is embodied in the shape of a ring in relation to the symmetry line 32; the decoupling element 21 is given a multiaxial flexibility by the embodiment of the compensation region according to FIG. 4.2 with wave crests 25, wave troughs 26, and inclined flanks 37.

It can be inferred from the embodiments of the decoupling element 21 proposed according to the invention described above that the compensation region 22, 23, which gives the decoupling element 21 its multiaxial flexibility and deformability, can be embodied in a multitude of variations. All of the embodiments in the above-mentioned figures share the common trait that they permit the decoupling element 21 to be contained on the inside of the shielded tube 3 in a multiaxially mobile fashion. Characteristic of the thin-walled material, which is embodied with a high degree of deformability, is a capacity of the valve tube 4 downstream in the flow direction to fit snugly against the outer contour of a pivotable valve flap 6, which is required to achieve a maximal sealing action in the closed position 17 of the valve flap 6. This effectively prevents the valve flap 6 from pivoting while in its closed position 18 so that no misrouting of air can occur in the closed position of the throttle valve. The ease with which the decoupling element 21 deforms the valve tube 4 inside the shielded tube 3 also permits the adjusting motor 16, which actuates the flap shaft 17, to be embodied in a small form so that precisely the minimal driving force required to pivot the valve flap 6 can be produced. In order to reduce the burden on the adjusting motor 16 that actuates the valve flap 6, a restoring spring 15 is accommodated underneath the adjusting motor 6 and encourages the restoring motion of the valve flap 6 and likewise permits the motor to be embodied in a smaller form.

Reference Numeral List

1 flap valve

2 valve housing

3 shielded tube

4 valve tube

5 fitting

6 valve flap

7 flap shaft

8 axis

9 incoming gas flow

10 outgoing gas flow

11 connecting flange

12 connecting flange

13 fitting axis

14 sealing ring

15 restoring spring

16 adjusting motor

17 first flap position

18 second flap position

19 cross sectional surface

20 contact region

21 decoupling element

22 compensation region

23 bellows

24 vertical wave formation

25 wave crest

26 wave trough

27 inside position

28 outside position

29 combined wave formation

30 horizontal wave formation

31 wall

32 symmetry line

33 circumferential edge

34 combined wave formation

35 fastening region

36 tube

37 inclined flank

1. A flap valve for controlling a gas flow (9, 10), with a shielded tube (3), which conveys the gas flow, and a valve flap (6) disposed in it, which can pivot between an open position (18) and a closed position (17), is stationarily supported on an adjustable flap shaft (7), covers the cross section (19) in the shielded tube (3) in the closed position (17), and maximally opens this cross section in the open position (18), and an acute angle α is enclosed between the axis (8) of the flap shaft (7) and the axis (13) of the fitting (5, 3), characterized in that the pivotable valve flap (6) is encompassed in the shielded tube (3) by a valve tube (4), which contains a decoupling element (21).

2. The flap valve according to claim 1, characterized in that the decoupling element (21) is connected to the shielded tube (3) in a fastening region (35).

3. The flap valve according to claim 1, characterized in that the decoupling element (21) is embodied as a deformation region (22, 23) that extends axially in relation to the valve flap (6).

4. The flap valve according to claim 3, characterized in that an annular gap extends between the wall (31) of the decoupling element (21) and the inner wall of the shielded tube (3).

5. The flap valve according to claim 1, characterized in that the decoupling element (21) extends axially through the shielded tube (3) in the flow direction of the gas flow (9, 10).

6. The flap valve according to claim 3, characterized in that the compensation region (22, 23) is embodied as an axially vertical wave formation (24) in the wall (31) of the decoupling element (21).

7. The flap valve according to claim 6, characterized in that the compensation region (22, 23) of the decoupling element (21) is embodied as a wave formation in an inside position (27).

8. The flap valve according to claim 6, characterized in that the compensation region (22, 23) of the decoupling element (21) is embodied as a wave formation (24) in an outside position (28).

9. The flap valve according to claim 6, characterized in that the compensation region (22, 23) of the decoupling element (21) is embodied as a wave formation (24) in a combined inside/outside position (29).

10. The flap valve according to claim 3, characterized in that the compensation region (22, 23) of the decoupling element (21) is embodied as a horizontal wave formation (30).

11. The flap valve according to claim 3, characterized in that the compensation region (22, 23) is embodied as a combination of a vertical and horizontal wave formation (24, 30).

12. The flap valve according to claim 3, characterized in that the compensation region (22, 23) of the decoupling element (21) is embodied as a wave formation (25, 26) with inclined flanks (37).

13. The flap valve according to claim 12, characterized in that the inclined flanks (37) in an inside position (27) on the decoupling element (21) function as a throttle cross section in the shielded tube (3).
